(19) United States
(12) Patent Application Publication
(10) Pub. No.: US 2006/0059053 A1
(43) Pub. Date: Mar. 16, 2006

(54) Method to identify, discover, and/or sell products via a web site on the internet

(76) Inventor: Harrison Robert Payne, Beverly Hills, CA (US)

Correspondence Address: HAHN LOESER & PARKS, LLP, One GOJO Plaza, Suite 300, AKRON, OH, 44311-1076, US

(21) Appl. No.: 11/144,376

(22) Filed: Jun. 3, 2005

Related U.S. Application Data
(60) Provisional application No. 60/577,275, filed on Jun. 4, 2004.

(51) Int. Cl. G06Q 30/00

(52) U.S. Cl. 705/26

(57) ABSTRACT

A method and system for doing business and generating revenue via a web site are disclosed. The method includes listing at least one media form on a web site hosted on a computer-based platform. The method also includes listing at least one product featured in the at least one media form on the web site and providing access to the web site via a global information network. The method further includes adapting the web site such that users of the web site may identify, discover, and/or purchase the at least one featured product via the web site. Revenue is generated via various mechanisms using the web site.

### CROSS-REFERENCE TO RELATED APPLICATIONS/INCORPORATION BY REFERENCE

This application claims priority to U.S. Provisional Patent Application Ser. No. 60/577,275 filed on Jun. 4, 2004 and which is incorporated herein by reference in its entirety.

### TECHNICAL FIELD

Certain embodiments of the present invention relate to doing business over the Internet. More particularly, certain embodiments of the present invention relate to a method and system for generating revenue via a web site by listing and selling products on the web site which are featured in, for example, films of movies.

### BACKGROUND OF THE INVENTION

At present, there are many web sites that may be accessed over the Internet such that products and services may be purchased via the Internet from the web sites. Many different types of products and services are offered.

In 2003, the American public spent tens of billions of dollars to enjoy films in theatres and in their homes. Also, the overseas markets often generate an additional 100% of a film's domestic box office take and offer significant revenue from home video sales and international television.

Film companies and television networks often feature real products within their films and television programs. For example, a certain film may feature a certain type of video camera in a particular scene of the film. As another example, a popular television program may feature a certain type of clothing in an episode of the television program.

Major film studios handle production, marketing, and distribution of major commercial films, including product placement. These studios work with product placement agencies that represent a collection of Fortune 500 clients to place products in films with the right target audience. Product placement agencies operate like an outsourced entertainment marketing division, helping their clients maximize their involvement with individual films.

Product placement has grown tremendously over the last few years as corporate marketers search for more cost-effective ways to reach consumers. By placing their products in major films, they may get tens of millions of impressions in a powerful branding opportunity thanks to the implied endorsement of the stars who are using or wearing those products.

It is hypothesized that certain consumers who view these films and television programs often desire to identify and purchase some of these featured products. However, these consumers may not have a convenient way to go about purchasing the products. There has been no easy way for consumers to find out exactly what they have seen on screen and then actually purchase the items. Without a closed loop, the studios and their corporate clients have not been able to measure the impact of product placement in concrete sales.

Further limitations and disadvantages of conventional, traditional, and proposed approaches will become apparent to one of skill in the art, through comparison of such systems and methods with the present invention as set forth in the remainder of the present application with reference to the drawings.

### BRIEF SUMMARY OF THE INVENTION

An embodiment of the present invention comprises a method of doing business via a web site. The method comprises listing at least one media form (e.g., film, music video, live concert, television show, etc.) on a web site hosted on a computer-based platform and listing at least one product featured in the media form on the web site. The method further comprises providing access to the web site over a global information network (e.g., the Internet) and adapting the web site to allow users of the web site to identify, discover, and/or purchase the featured products via the web site.

The method may be used to generate revenue via the web site. For example, permission may be obtained from at least one owner of the at least one media form to list the media form and the at least one product featured in the media form on the web site. Also, permission may be obtained from at least one vendor of the product to list the product for sale on the web site. An agreement may be entered into with the vendor for the vendor to pay at least one fee associated with listing the product on the web site.

Another embodiment of the present invention comprises a system for doing business. The system comprises a loop-closing web site hosted on a first computer-based platform. The loop-closing web site is adapted to list at least one media form and at least one product featured in the media form on the loop-closing web site. The system further comprises at least a second computer-based platform and a global information network operationally connecting the first computer-based platform to at least the second computer-based platform such that a user of the second computer-based platform can access the web site to identify, discover, and/or purchase the featured product via the web site.

These and other advantages and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a flow chart of an embodiment of a method of doing business via a web site, in accordance with various aspects of the present invention.

FIG. 2 is an exemplary schematic illustration of an embodiment of a system for implementing the method of FIG. 1, in accordance with various aspects of the present invention.

FIG. 3 is a flowchart of an embodiment of a method for generating revenue via a web site using the method of doing business of FIG. 1 and the system of FIG. 2, in accordance with various aspects of the present invention.

### DETAILED DESCRIPTION OF THE INVENTION

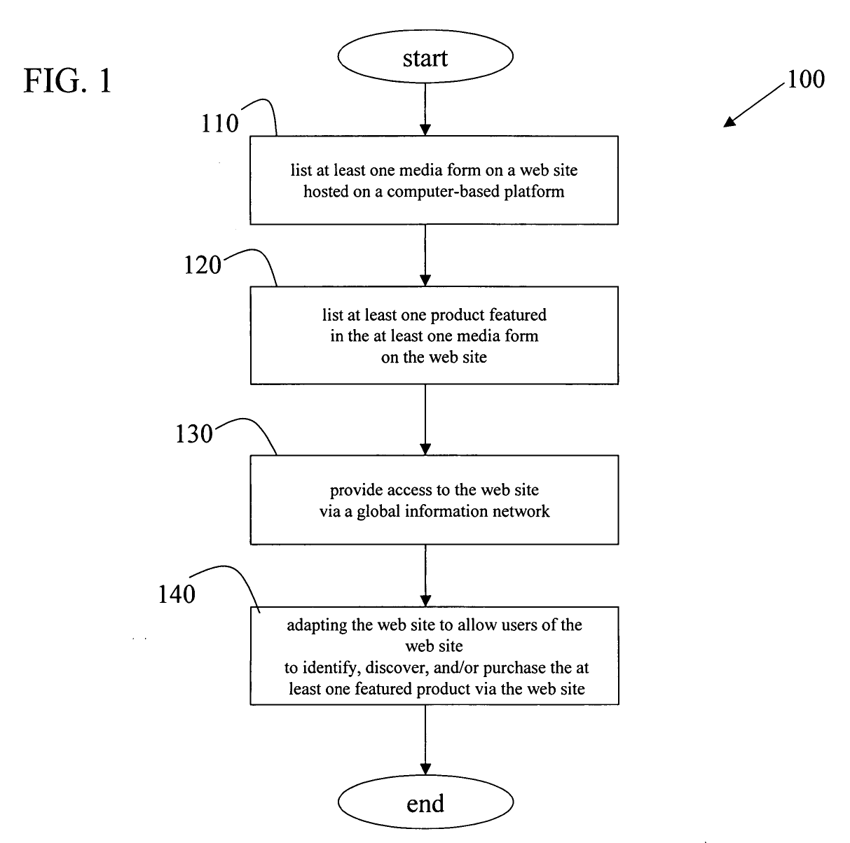

FIG. 1 is a flow chart of an embodiment of a method 100 of doing business via a web site, in accordance with various aspects of the present invention. In step 110, at least one media form is listed on a web site which is hosted on a computer-based platform (e.g., a server). In step 120, at least one product featured in the at least one media form is listed on the web site. In step 130, access to the web site is provided via a global information network (e.g., the Internet). In step 140, the web site is adapted to allow users of the web site to identify, discover, and/or purchase the at least one featured product via the web site.

In accordance with various embodiments of the present invention, media forms may comprise, for example, films, television programs, music videos, and live performances such as concerts. As an example, a film may feature an actor wearing a certain brand of leather jacket. Certain viewers of the film may desire to identify, discover, and/or purchase the same brand of leather jacket worn by the actor in the film. The method 100 of FIG. 1 provides a means for the viewers of the film to acquire (i.e., purchase) the leather jacket. Similarly, certain viewers of a music video may desire to purchase an item seen in the music video. Attendees of a concert may desire, for example, to purchase concert tour props and costumes seen at the concert.

As an example, a provider of the web site works with movie studios to “sign up” films and then offer a program directly to manufacturers whose products are placed in the films. Highly targeted customers browse and search for products by film or by category using the web site and view a list of thumbnails and descriptions. When a customer clicks to learn more about a specific product, the provider of the web site may earn a click-through fee from the manufacturer of the product.

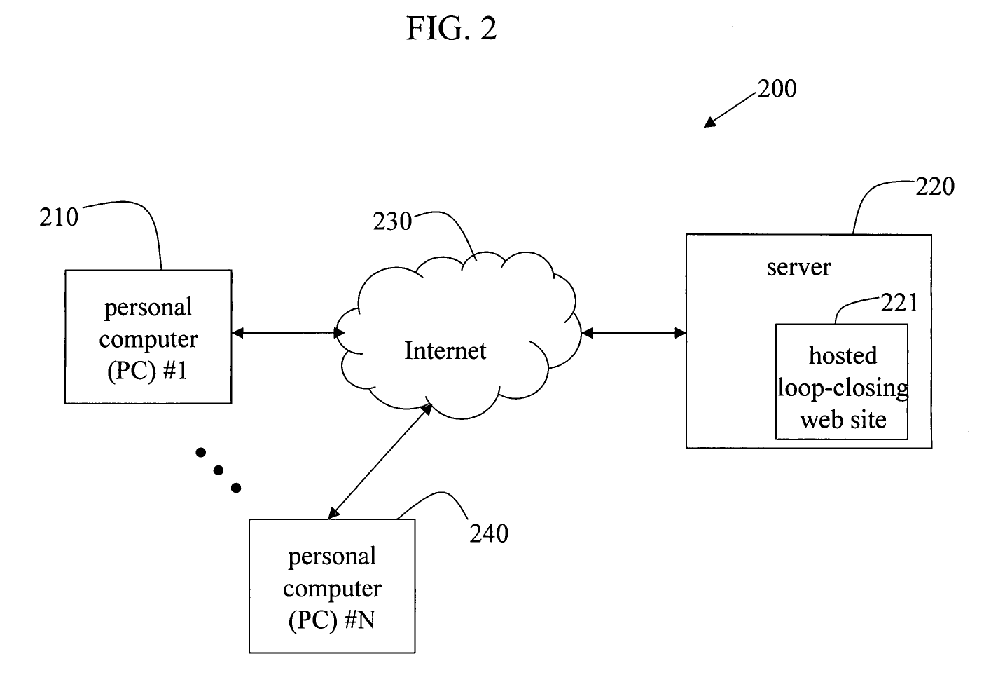

FIG. 2 is an exemplary schematic illustration of an embodiment of a system 200 for implementing the method 100 of FIG. 1, in accordance with various aspects of the present invention. The system 200 comprises a first computer-based platform 220 (e.g., a server) hosting a loop-closing web site 221. The first computer-based platform 220 is operationally connected to a global information network 230 (e.g., the Internet). The loop-closing web site 221 is adapted to list various media forms and featured products and is designed to allow a user to purchase the featured products “on-line” via the web site 221 over the Internet 230 using a second computer-based platform (e.g., one of the PC's, PC #1 210 through PC #N 240), in accordance with an embodiment of the present invention. That is, the loop-closing web site 221 closes the loop between the media consumer (e.g., the movie-goer) and the products featured in the media form (e.g., a film). The web site 221 provides brand recognition to manufacturers' products, allows users to identify products seen in media forms, allows users to discover new products, and allows users to purchase products.

For example, a user watches a television program and sees a pair of unusual sunglasses that a particular character in the television show is wearing. The user then gets on the Internet 230 using his PC 210 and goes to the loop-closing web site 221 which is hosted on the server 220. The user finds the television program listed on the loop-closing web site 221, clicks on the listed television program on the loop-closing web site, and views a list of products that were featured in the television program, including the unusual sunglasses. The user proceeds to click on the listed sunglasses, views a price of the sunglasses, and proceeds to follow a process to purchase the sunglasses on-line. Within five days, a pair of the unusual sunglasses arrive at the users home via a shipping service.

The provider of the loop-closing web site 221 signs up studio films to be included in the loop-closing web site 221 and sells a program directly to the product placement agencies or to the manufacturers of the products. Manufacturers that do not sign a placement deal in a film do not participate in the loop-closing web site program. The provider of the loop-closing web site 221 handles contracts, data gathering, and billing with the participating manufacturers. Placement firms may earn a commission on click-through fees. Such commissions serve as an inducement for the product placement firms to act as a sales agent to the provider of the loop-closing web site with no direct costs.

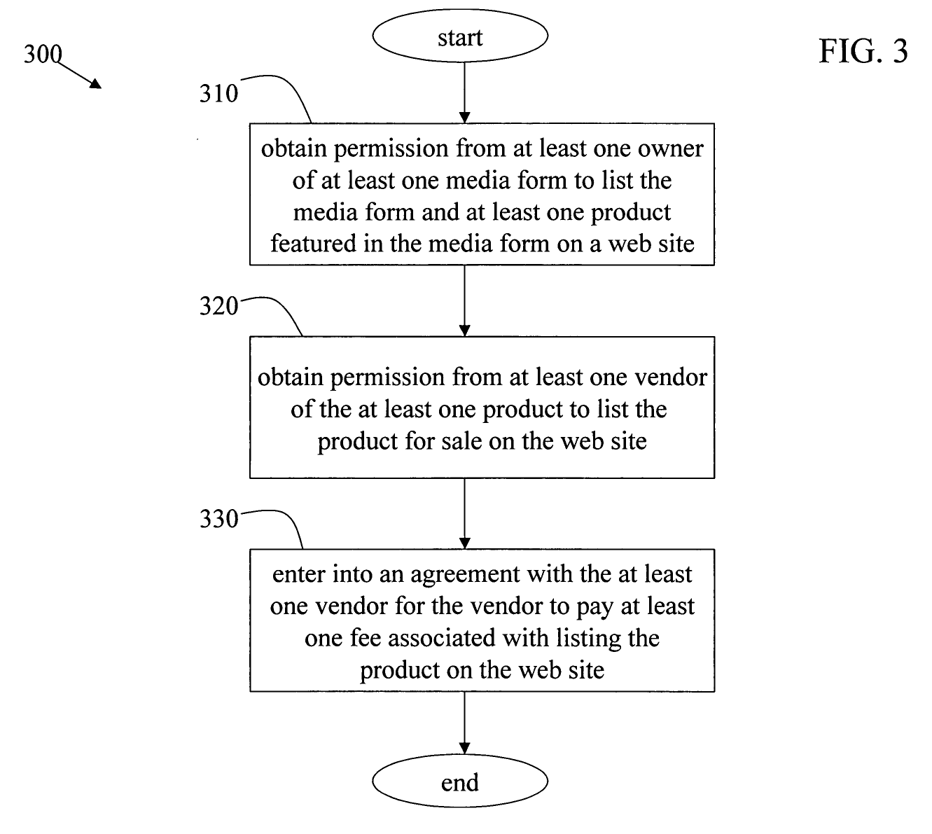

FIG. 3 is a flowchart of an embodiment of a method 300 for generating revenue via a loop-closing web site using the method 100 of doing business of FIG. 1 and system 200 of FIG. 2, in accordance with various aspects of the present invention. In step 310, permission is obtained from at least one owner of the at least one media form to list the at least one media form and the at least one featured product featured in the media form on the loop-closing web site. In step 320, permission is obtained from at least one vendor of the at least one product to list the product for sale on the loop-closing web site. In step 330, an agreement is entered into with the at least one vendor for the vendor to pay at least one fee associated with listing the product on the loop-closing web site.

For example, the provider of the loop-closing web site 221 approaches a film company and obtains permission to list a film owned by the film company and three products featured in the film on the loop-closing web site 221. The three products are all manufactured by a single vendor. The provider of the loop-closing web site 221 next approaches the single vendor and obtains permission from the single vendor to list all three products for sale on the loop-closing web site 221. Also, the provider of the loop-closing web site 221 enters into an agreement with the single vendor such that the single vendor will pay to the loop-closing web site provider an initial set-up fee to have the three products listed on the loop-closing web site 221 (e.g., $350), and a commission on each instance of any of the three products sold via the loop-closing web site 221 (e.g., 5% of the sales price is a commission that goes to the loop-closing web site provider and 95% of the sales price goes to the vendor). The agreement also allows the single vendor to pay a “click through” fee for each hit on the single vendor's products. That is, whenever a user of the loop-closing web site 221 clicks on any one of the three listed products, the vendor will be required to pay the “click through” fee (e.g., $0.30 per hit).

In accordance with an embodiment of the present invention, the loop-closing web site provider not only lists the media forms and featured products on the loop-closing web site 221 but also provides other information with respect to the media forms and featured products. For example, the loop-closing web site 221 may provide biographical information on actors appearing in the listed films. Also, the loop-closing web site 221 may provide detailed product information on each featured product listed.

In accordance with an embodiment of the present invention, the loop-closing web site 221 allows a user to click and go directly to the manufacturer's product page on their web site. The user is not just sent to the manufacturer's home page, for example, and then required to click through potentially multiple layers of web pages to get to the specific product.

In accordance with an embodiment of the present invention, the provider of the loop-closing web site 221 approaches a product placement firm (i.e., a firm that places products in media forms such as films, etc.), and agrees to pay a commission to the product placement firm for products sold on the loop-closing web site 221 that were placed by the product placement firm in the listed media forms. As a result, an incentive is provided to the product placement firm to try to place products in various media forms that the loop-closing web site provider is interested in listing on the loop-closing web site 221.

For example, the loop-closing web site provider determines that it has much success in selling electronic gadgets via the web site 221. The loop-closing web site provider has a very good business relationship with an electronic gadget vendor. As a result, the loop-closing web site provider approaches a product placement firm and encourages the product placement firm to try to place electronic gadgets made by the electronic gadget vendor into various upcoming films. In return, the loop-closing web site provider agrees to pay a commission to the product placement firm as described above.

Manufacturers add value to their placement deals by generating measurable traffic and potentially, trackable sales, creating a measurable marketing program from one that was not measurable. Also, manufacturers generate sales from consumers who may have liked the product on screen but never followed through to actually purchase it. Once these consumers are on the manufacturer's web site (via the loop-closing web site 221), they may purchase additional products or return to the site at a later date, creating residual value for the manufacturer. Consumers may purchase directly via the web site or may simply find out and learn about the product via the web site and then go directly to the manufacturer or to a retail outlet to purchase the product. Manufacturers also reap the benefits of the promotional expenditures of the provider of the loop-closing web site.

Film studios can use the data from the traffic on the loop-closing web site to prove the effectiveness of product placement, and use that data to sell more lucrative future placement deals. The film studios can offer tangible additional exposure for their placement deals without additional resource requirements. The film studios can build overall consumer demand for the products seen on screen, which can lead to more lucrative future cash deals. The film studios can create more exclusivity and value for their placement deals because only those clients will be allowed to display their products on the loop-closing web site 221. Manufacturers whose products are not used on screen via a placement deal cannot participate in the loop-closing web site program offered by the provider of the loop-closing web site.

With respect to the loop-closing web site 221, users can browse great products by, for example, film or by product type. Other categories such as, for example, “actor” are possible as well. Each time a user clicks “More Info” on a page of thumbnail images, the provider of the loop-closing web site 221 earns a click-through fee from the manufacturer. The button takes the user directly to the manufacturer's web site to learn about the product in detail, get pricing, and order online or find a retailer. The provider of the loop-closing web site may offer several volume tiers that cap a client's annual expenditures based on the client's industry and sales potential, enabling manufacturers of all sizes to participate without risk.

A setup fee may be charged to client's for each product to be featured on the loop-closing web site (capped for larger clients). To entice manufacturers to try the loop-closing web site, the provider of the loop-closing web site may waive setup fees for the first several months, meaning that there is no risk for companies to sign up and start generating sales from their movie placements.

The provider of the loop-closing web site may also generate revenue from advertising banners displayed on the loop-closing web site and/or customized marketing programs developed for specific clients.

In accordance with an alternative embodiment of the present invention, the closed loop provider may provide a kiosk in the lobby of a movie theatre. The kiosk is used to perform a similar function to the closed loop web site described previously herein. For example, a movie-goer may purchase products associated with certain movies at the kiosk in the movie theatre.

Also, in accordance with another alternative embodiment of the present invention, the closed loop provider may advertise in print media or on television or radio, for example in order to complete the loop. A customer could order products associated with certain movies using the information provided in the advertisement (e.g., movies, products, price, an address to send away for the products, etc.).

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A method of doing business via a web site, said method comprising:
listing at least one media form on a web site hosted on a computer-based platform;
listing at least one product featured in said at least one media form on said web site;
providing access to said web site via a global information network; and
adapting said web site to allow users of said web site to identify, discover, and/or purchase said at least one featured product via said web site.

2. The method of claim 1 wherein said at least one media form comprises a film.

3. The method of claim 1 wherein said at least one media form comprises a television program.

4. The method of claim 1 wherein said at least one media form comprises a live performance.

5. The method of claim 1 further comprising providing information associated with said at least one media form and said at least one product on said web site.

6. The method of claim 1 wherein said computer-based platform comprises a server connected to said global information network.

7. The method of claim 1 wherein said web site is accessed by said users via a personal computer (PC) connected to said global information network.

8. The method of claim 1 wherein said global information network comprises the Internet.

9. The method of claim 1 further comprising generating revenue from said web site by:
obtaining permission from at least one owner of said at least one media form to list said at least one media form and said at least one product featured in said at least one media form on said web site;
obtaining permission from at least one vendor of said at least one product to list said at least one product for sale on said web site; and
entering into an agreement with said at least one vendor for said at least one vendor to pay at least one fee associated with listing said at least one product on said web site.

10. The method of claim 9 wherein said at least one fee comprises a set up fee for listing for sale said at least one product on said web site.

11. The method of claim 9 wherein said at least one fee comprises a “click through” fee for each instance of a web site hit on said at least one product.

12. The method of claim 9 wherein said at least one fee comprises a commission on each instance of said at least one product sold via said web site.

13. The method of claim 1 further comprising paying a commission to at least one product placement firm for products sold on said web site that were placed by said product placement firm in said at least one media form.

14. The method of claim 1 wherein said adapting said web site to allow users of said web site to identify, discover, and/or purchase said at least one featured product via said web site includes said web site directing said users to a product page of a vendor or manufacturer web site.

15. A system for doing business, said system comprising a loop-closing web site hosted on a first computer-based platform which is operationally connected to a global information network, and wherein said loop-closing web site is adapted to list at least one media form and at least one product featured in said at least one media form on said loop-closing web site.

16. The system of claim 15 further comprising at least a second computer-based platform operationally connected to said global information network such that a user of said second computer-based platform can access said loop-closing web site to identify, discover, and/or purchase said at least one featured product via said loop-closing web site.

17. The system of claim 15 wherein said first computer-based platform comprises a server.

18. The system of claim 16 wherein said second computer-based platform comprises a personal computer (PC).

19. The system of claim 15 wherein said global information network comprises the Internet.

20. The system of claim 15 wherein said at least one media form comprises a film.

21. The system of claim 15 wherein said at least one media form comprises a television program.

22. The system of claim 15 wherein said at least one media form comprises a live performance.

23. The system of claim 15 wherein information associated with said at least one media form and said at least one product is provided on said loop-closing web site.

24. The system of claim 15 wherein revenue is generated from said loop-closing web site by:
obtaining permission from at least one owner of said at least one media form to list said at least one media form and said at least one product featured in said at least one media form on said loop-closing web site;
obtaining permission from at least one vendor of said at least one product to list said at least one product for sale on said loop-closing web site; and
entering into an agreement with said at least one vendor for said at least one vendor to pay at least one fee associated with listing said at least one product on said loop-closing web site.

25. The system of claim 24 wherein said at least one fee comprises a set up fee for listing for sale said at least one product on said loop-closing web site.

26. The system of claim 24 wherein said at least one fee comprises a “click through” fee for each instance of a web site hit on said at least one product.

27. The system of claim 24 wherein said at least one fee comprises a commission on each instance of said at least one product sold via said loop-closing web site.

28. The system of claim 15 wherein a commission is paid to at least one product placement firm for products sold on said loop-closing web site that were placed by said product placement firm in said at least one media form.

29. The system of claim 16 wherein said user is directed to a product page of a vendor or manufacturer web site via said loop-closing web site to identify, discover, and/or purchase said at least one featured product.
